(19) United States
(12) Patent Application Publication
(10) Pub. No.: US 2022/0242792 A1
(43) Pub. Date: Aug. 4, 2022

(54) WHITENING METHODS AND COMPOSITIONS

(71) Applicant: ILUKA RESOURCES LIMITED, Perth (AU)

(72) Inventors: Jorge de Luna MASBATE JR., East Perth (AU); Pedro Javier LIBERAL RODRIGUEZ, Leederville (AU); Nicholas Glen BERNARD, Gelorup (AU); Joaquin PIQUER MARTI, Onda (ES)

(21) Appl. No.: 17/629,609

(22) PCT Filed: Jul. 24, 2020
(86) PCT No.: PCT/AU2020/050753

§ 371 Date: Jan. 24, 2022

Related U.S. Application Data
(60) Provisional application No. 62/878,208, filed on Jul. 24, 2019.

(51) Int. Cl. C04B 33/14; C04B 33/04; C04B 33/34; C04B 41/45; C04B 41/00; C04B 41/50; C04B 41/86

(52) U.S. Cl. CPC C04B 33/14; C04B 2235/9661; C04B 33/34; C04B 41/4578; C04B 41/0072; C04B 41/5024; C04B 41/86; C04B 2235/3217; C04B 2235/3248; C04B 2235/3206; C04B 2235/3208; C04B 2235/349; C04B 2235/3427; C04B 2235/3418; C04B 2235/656; C04B 33/04

(57) ABSTRACT

A metal oxide composition for use in ceramic bodies to form a ceramic whitener-opacifier composition is disclosed. The metal oxide composition includes one or more crystalline metal oxides or crystalline mixed metal oxides of Al, Ca, Mg, Si and Zr. The metal oxide composition includes at least (i) Al in an amount of from about 5 wt % to about 40 wt % measured as Al2O3, (ii) Ca in an amount of from about 10 wt % to about 30 wt % measured as CaO, (iii) Mg in an amount 5 of from about 0 wt % to about 25 wt % measured as MgO, (iv) Si in an amount of from about 10 wt % to about 25 wt % measured as SiO2, and (v) Zr in an amount of from about 15 wt % to about 35 wt % measured as ZrO.

### CROSS-REFERENCE TO RELATED APPLICATIONS

This application claims benefit of and priority to U.S. Provisional Patent Application Ser. No. 62/878,208 filed Jul. 24, 2020, titled Whitening Compositions and Methods. and is hereby incorporated by reference in its entirety, to the extent it is not inconsistent herewith.

### BACKGROUND

### Technical Field

The invention relates to a metal oxide composition for use as an additive to form a ceramic whitener-opacifier composition, methods of forming the metal oxide composition, and ceramic compositions including the metal oxide composition.

### Background of the Invention

Opacification and whitening in ceramics, whether in full body tiles or in the engobes and glazes is primarily imparted through the presence of crystalline phases in the final fired product which is largely a glass (typically 60-70% amorphous, i.e. 30-40% crystalline). The presence of crystalline phases causes scattering of the incident light which provides the appearance of opacification and white coloration. Further, the effectiveness of the crystalline phase as a whitener-opacifier agent relies on the difference in the refractive index of the crystalline phase relative to the glassy phase, the larger the better.

Zirconium silicate (commonly referred to as zircon) is one of the most effective whitener-opacifier agents due to its higher refractive index of 1.92 relative to that of the glass (˜1.5) and due to its stability over the typical firing range of traditional ceramics (1100° C.-1250° C.). Zircon is usually added to the ceramic composition as a finely ground mineral (0.8-1.8 microns D50) and remains unchanged throughout the tile production process and functions as a whitener-opacifier agent through its light scattering properties which are a function mainly of the material's refractive index, loading intensity and the particle size. Zircon is the preferred whitener-opacifier agent due to its high refractive index, case of deflocculation, chemical resistance, etc. There are other materials that are used in place of zirconium silicate such as alumina-based materials. However, these materials generally demonstrate inferior whitening properties compared to zirconium silicate and often result in other undesirable properties such as substantial increase in refractoriness of the ceramic composition (requiring higher firing temperatures) and reduction in tile body strength.

There is an emergent trend for large format porcelain tiles and slabs (which slabs may be around 20 mm thick, such as for use in benchtops, tables) with sizes greater than 1.2 m×3.6 m; and for forming tiles in which the whole tile has the same composition (‘full body tiles’). This contrasts with more traditional glazed ceramic tiles in which a tile body is coated with a glaze (and sometimes with an engobe between the body and the glaze) which provides the final appearance and surface finish and hides the body itself. It will be appreciated that strength (green dry and fired) is an increasingly important requirement as tile formats increase in size. Thus, the MOR (modulus of rupture) of the tile in the green, dry and fired states is becoming increasingly important for these large format tiles. To increase the MOR of tile bodies, tile producers have several options:

Organic binders may be added to the tile composition. However, organic binders produce undesired aesthetics, so-called ‘black cores’ or dark spots which remain in the porcelain body after firing and which can interfere with desired tile designs.

Inorganic binders may be added to the tile composition. However, these products are darker in color, which results in a loss of whiteness (or a darkening) in the fired tiled.

Reformulate the composition to add more clay. But since clays typically contain higher chromophore contaminants, the reformulated composition would lead to a loss in whiteness (i.e. resultant darkening) in the fired tile.

From the above, it is apparent that the current solutions for increasing the green/dry MOR lead to darker, less-white bodies. Currently, there are no MOR-enhancing products that deliver enhanced strength while also delivering high-whiteness to the tile body. The present invention seeks to ameliorate at least one of the shortcomings discussed above.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY

In a first aspect of the invention, there is provided a metal oxide composition including one or more crystalline single metal oxides and/or crystalline mixed metal oxides; wherein the metal oxide composition includes:

Al in an amount of from about 5 wt % up to about 40 wt % measured as Al₂O₃;

Ca in an amount of from about 15 wt % up to about 50 wt % measured as CaO;

Mg in an amount of from about 0 wt % up to about 20 wt % measured as MgO;

Si in an amount of from about 5 wt % up to about 20 wt % measured as SiO₂;

Zr in an amount of from about 15 wt % up to about 35 wt % measured as ZrO₂;

and wherein the amount of Si is 25 to 35 wt % of the amount of Zr.

In an embodiment, the metal oxide composition is for use as a whitener-opacifier additive or a component of a whitener-opacifier in the production of a ceramic body, such as a tile, or as a whitener-opacifier agent in engobes and glazes for a ceramic body.

The inventors have found that the metal oxide compositions of the present invention can, in certain embodiments, provide enhanced strength to the green tile body (typically with a moisture content of about 5-6 wt %) and/or the dry tile body (typically with a moisture content of about 0.5 wt %) and/or the fired tile body. Furthermore, in one or more embodiments, the metal oxide compositions when used as a component of a whitener-opacifier can enhance the whiteness of a tile produced using that whitener-opacifier and/or reduce the firing temperature to produce a tile while maintaining a high degree of whiteness.

In an embodiment, the amount of Al (expressed as the oxide) is from about 7 wt %. Preferably, the amount of Al is from about 10 wt %. Most preferably, the amount of Al is from about 12 wt %. Additionally, or alternatively, the amount of Al is up to about 30 wt %. Preferably, the amount of Al is up to about 20 wt %. Most preferably, the amount of Al is up to about 25 wt %. For example, in one form the range is from 5 to 25 wt %.

In an embodiment, the amount of Ca (expressed as the oxide) is from about 20 wt %. Preferably, the amount of Ca is from about 25 wt %. Most preferably, the amount of Ca is from about 30 wt %. Additionally, or alternatively, the amount of Ca is up to about 45 wt %. Preferably, the amount of Ca is up to about 40 wt %. Most preferably, the amount of Ca is up to about 35 wt %. For example, in one form the range is from 33 to 35 wt %.

In an embodiment, the amount of Mg (expressed as the oxide) is greater than 0 wt %. Preferably, the amount of Mg is from about 0.5 wt %. More preferably, the amount of Mg is from about 3 wt %. Most preferably, the amount of Mg is from about 5 wt %. Additionally, or alternatively, the amount of Mg is up to about 18 wt %. Preferably, the amount of Mg is up to about 16 wt %. Most preferably, the amount of Mg is up to about 14 wt %. For example, in one form the range is from 6 to 7 wt %.

In an embodiment, the amount of Si (expressed as the oxide) is from about 8 wt %. Preferably, the amount of Si is from about 10 wt %. Most preferably, the amount of Si is from about 12 wt %. Additionally, or alternatively, the amount of Si is up to about 18 wt %. Preferably, the amount of Si is up to about 16 wt %. Most preferably, the amount of Si is up to about 15 wt %. For example, in one form the range is from 13 to 14 wt %.

In an embodiment, the amount of Zr (expressed as the oxide) is from about 18 wt %. Preferably, the amount of Zr is from about 20 wt %. Most preferably, the amount of Zr is from about 22 wt %. Additionally, or alternatively, the amount of Zr is up to about 32 wt %. Preferably, the amount of Zr is up to about 30 wt %. Most preferably, the amount of Zr is up to about 28 wt %. For example, in one form the range is from 25 to 27 wt %.

In an embodiment, the metal oxide composition includes optional incidental impurities. The incidental impurities may be present in an amount of 2 wt % or less. Preferably, the incidental impurities are present in an amount of 1 wt % or less. More preferably, the incidental impurities are present in an amount of 0.1 wt % or less. Most preferably, the incidental impurities are present in an amount of 0.01 wt % or less.

In an embodiment, the metal oxide composition consists of, or consists essentially of: Al, Ca, Mg, Si, Zr, and optional incidental impurities.

In one form, the incidental impurities are minerals or compounds that include metal or metalloid elements other than Al, Ca, Mg, Si, and Zr. Additionally, or alternatively, the incidental impurities are non-oxide or silicate containing metal or metalloid salts.

In a second aspect of the invention, there is provided a zircon-metal oxide containing whitener-opacifier including zircon and the metal oxide composition of the first aspect (or embodiments thereof).

In a third aspect of the invention, there is provided a method for forming the zircon-metal oxide containing whitener-opacifier, the method including blending zircon with the metal oxide composition of the first aspect (or embodiments thereof). In an embodiment, the zircon-metal oxide containing whitener-opacifier for use in ceramic bodies may include zircon silicate blended with from any of: 10-90 wt %, 20-30 wt % and/or 30% to 90 wt % of the metal oxide composition of the first aspect (or embodiments thereof).

In a fourth aspect of the invention, there is provided a method for forming a green ceramic body including: adding from about 0.1 wt % to about 20 wt % of the metal oxide composition of the first aspect (or embodiments thereof) or the zircon whitener-opacifier composition of the third and fourth aspects (or embodiments thereof) to a base ceramic composition and forming a green ceramic body.

In a fifth aspect of the invention, there is provided a method for coating or glazing a green ceramic body including: coating or glazing at least one surface of a green ceramic body with the composition of the first aspect (or embodiments thereof) or the third and fourth aspects (or embodiments thereof).

The green ceramic body may be a green ceramic body according to the fifth aspect of the invention, or a standard green ceramic body known to those skilled in the art. By way of example, the standard green ceramic body may be formed from a base ceramic composition and thus does not itself include the zircon-metal oxide containing whitener-opacifier.

In an embodiment, the method is for coating a green ceramic body with an engobe, and the composition is an engobe composition.

In an embodiment of the fifth or sixth aspects, the green ceramic body is a green ceramic tile body.

In a sixth aspect of the invention, there is provided a green ceramic body formed according to the method of the fourth or fifth aspects (or embodiments thereof).

In a seventh aspect of the invention, there is provided a method of forming a ceramic, the method including:

forming a green ceramic body according to the method of the fourth or fifth aspects (or embodiments thereof); and firing the green ceramic body to form the ceramic.

The skilled person will appreciate that additional process steps may be present between the steps of forming the green ceramic body and firing the green ceramic body. For example, in one or more embodiments, after forming the green ceramic body and prior to firing the green ceramic body, the method includes drying the green ceramic body and optionally applying an engobe composition and/or a glaze composition to a surface of the green ceramic body.

In some embodiments the green ceramic body may be fired using an average firing temperature of 1,220° C. to form the ceramic. In some embodiments the green ceramic body may be fired within a range of from 1,1,150° C. to 1,250° C. to form the ceramic.

In an eighth aspect of the invention, there is provided a method of preparing a ceramic, the method including:

providing a green ceramic body including the metal oxide composition of the first aspect (or embodiments thereof) or the zircon whitener-opacifier composition of the third aspect (or embodiments thereof); and

firing the green ceramic body to form the ceramic.

In some embodiments the green ceramic body may be fired using an average firing temperature of 1,220° C. to form the ceramic. In some embodiments the green ceramic body may be fired within a range of from 1,1,150° C. to 1,250° C. to form the ceramic.

In a ninth aspect of the invention, there is provided a ceramic formed according to the fifth or sixth aspects of the invention.

In an embodiment of the seventh, eighth or ninth aspects, the ceramic is a ceramic tile.

In a tenth aspect of the invention, there is provided a ceramic composition according to the eighth or ninth aspects of the invention characterized by the following:

a whiteness (L*-value) of 87-97; and a stain mark (ΔE) of 1.40-4.75.

In an eleventh aspect of the invention, there is provided a ceramic composition of the tenth aspect, further characterized by a zircon load of from 0.1 wt % to 20 wt %.

In a twelfth aspect of the invention, there is provided an opacified ceramic composition characterized by the following properties: a whiteness (L*-value) of 87-97; a stain mark (ΔE) of 1.40-4.75; and a zircon load of from 0.1 wt % to 20 wt %.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: Graph of L-value (whiteness) as a function of whitener-opacifier loading for standard zircon whitener-opacifiers, and zircon-metal oxide whitener-opacifiers of the present invention.

FIG. 2: Graph of Stensby Index (whiteness) as a function of whitener-opacifier loading for standard zircon whitener-opacifiers, and zircon-metal oxide whitener-opacifiers of the present invention.

FIG. 3: Graph of whiteness (L) as a function of firing temperature for tile compositions including standard zircon whitener-opacifiers, and zircon-metal oxide whitener-opacifiers of the present invention.

FIG. 4: Graph illustrating green tile MOR, dry tile MOR, and fired tile MOR for compositions including standard zircon whitener-opacifiers, and zircon-metal oxide whitener-opacifiers of the present invention.

FIG. 5: Graph of stain mark as a function of tile firing temperature for standard zircon whitener-opacifiers, and zircon-metal oxide whitener-opacifiers of the present invention.

FIG. 6: Graph of fired apparent density as a function of tile firing temperature for tile compositions including standard zircon whitener-opacifiers, and zircon-metal oxide whitener-opacifiers of the present invention

FIG. 7: Graph of Watermark as a function of firing temperature for engobe compositions including standard zircon whitener-opacifiers, and zircon-metal oxide whitener-opacifiers of the present invention.

FIG. 8: Graph of whiteness (L) as a function of loading of zircon-metal oxide whitener-opacifiers of the present invention.

### DETAILED DESCRIPTION OF THE EMBODIMENTS

The invention relates to an Al, Ca, Mg, Si, and Zr containing metal oxide composition for use as an additive to form a zircon whitener-opacifier composition, methods of forming the metal oxide composition, and ceramic compositions including the metal oxide composition.

The metal oxide composition of the present invention is combinable with zircon to form a whitener-opacifier that produces similar whiteness as would be achieved with a 100% zircon whitener-opacifier. That is, the metal oxide composition allows for a zircon based whitener-opacifier that has a lower loading of zircon, while achieving the same or similar whiteness. This is a surprising outcome since the addition of these Al, Ca, Mg, Si, and Zr metal oxide constituents to a whitener-opacifier would usually be expected to have a deleterious effect on the overall whiteness provided by that whitener-opacifier. Notably, these Al, Ca. Mg, Si, and Zr metal oxide constituents would not normally be expected to deliver the same levels of whiteness as zircon.

While this of itself is a useful outcome, it has been found that the use of the metal oxide composition as a component of a zircon whitener-opacifier provides a number of unexpected benefits as compared with a straight zircon whitener-opacifier during a ceramic manufacturing process (and in particular in the manufacture of ceramic tiles). These improvements include enhanced green ceramic strength, dry ceramic strength, fired ceramic strength and ceramic porosity. The process of the ceramic manufacturing process is briefly described below in the context of the manufacture of tiles. Although the following description is written with regard to the manufacture of ceramic tiles, the use of the metal oxide composition as a component of a zircon whitener-opacifier may be used with the disclosed or alternative ceramic body formulations in the context of producing other ceramic products beyond ceramic tiles, such as refractory ceramic products.

Another benefit of the formulations and methods disclosed herein is the ability to reformulate ceramic bodies. Reformulation can be done to pursue two objectives. In the first objective, it may be desirable to reduce the energy needed to produce an opacified ceramic body. Reducing energy required to produce the opacified ceramic reduces operating costs. This may be accomplished by substituting materials to accommodate lower firing temperatures. In the second objective, it may be desirable to reformulate the opacified ceramic body to reduce the manufacturing costs of the ceramic product, for example through the use of lower cost materials to substitute for higher cost materials, such as high-purity fluxing materials. The strength and performance of the formulation of the invention in manufacturing ceramic products offers opportunities to use less expensive materials to form the ceramic body. For example, the presently disclosed and claimed whitener-opacifier formulations may permit the replacement in certain ceramic formulations of higher cost talc- and wollastonite-based fluxing materials with lower cost feldspar and/or clay materials.

The process of producing ceramic or porcelain tiles requires strength properties at the different stages of tile production for different reasons. Strength is measured and reported as a modulus of rupture (MOR) which is effectively a 3 point bending test to failure.

The tile formulation requires green strength to allow the mechanical handling/transport of the tile between the press and drier. Tile production is highly automated with green tiles exiting the press (hydraulic pressing into a mold or a continuous roller press) on rollers that transport the tile to the dryer. Sufficient strength is required to prevent deformation and, at worst, breakage, of the tile as in the case of pressed tiles they are flipped, and travel over the rollers to the drying stage. Likewise, the dry tile requires mechanical strength to allow transport through decoration stages (e.g. glazing/printing) and then to the firing kiln. The transport to and through the drying and firing furnaces is usually carried out on a series of ceramic rollers (typically 20-25 mm in diameter on 60 to 150 mm spacings). It is not uncommon, and highly undesirable, to see tiles adopt a corrugated profile from the rollers or outright breakage when strength has not adequately developed.

The strength of the final fired tile is important in terms of the final application such as wall and floor tiles. This is of particular importance as there is a trend towards larger format tiles (currently as large as 1.2 m×3.6 m but even 4.8 m are now being proposed) and thinner tiles (e.g. 6 mm for wall applications), and strength during the production process, transport to end user, and in the final product application are of high importance.

Surprisingly, when the metal oxide composition is included as part of a whitener-opacifier and/or mixed into the tile body, it has been found to result in increased strength in the fired tile.—green and particularly the dry state of the tile. This improvement is significant particularly in view of the trend to produce tiles of larger formats. Advantageously, this may allow the reduction (or elimination) of the need for mechanical strength additives or permit thinner tiles without compromising the strength.

In addition to the above, minimising porosity is also an important parameter for tiles as this relates to the degree to which the tile absorbs and adsorbs moisture and undesired stains, particularly when the final tile product has already been installed, such as in residential or commercial floors and walls. Stains absorption and adsorption can result in discoloration of the tile, particularly where the colorants are of substantially different color and optical property than the tile design (one of the tests of porosity involves tomato paste, olive oil and red wine amongst other things though the more conventional test is a permanent marker, dried and then washed off with acetone). The measure is usually termed the ‘stain mark’ for obvious reasons. By way of background, the stain mark measurement includes first measuring the whiteness of an area of the tile, then coating the area with blue ink (such as from a permanent marker), drying the area, washing the area with acetone, drying the area, and then again measuring the whiteness of the area of the tile. The “stain mark” is the square root of the sum of differences squared of the 3 parameters of colour measurement, L, a & b. Porosity usually develops from the dissolution of the tile ingredients into the glassy phase during firing. The individual particles of the different minerals are wetted by the developing glass and “dissolve” into the melt leaving a small void which then closes over if the viscosity of the glassy phase is sufficiently low enough. Voids that do not close over result in small voids or pinholes that traps discolorants and contaminants onto and into the surface of the tile after the tile has been polished. Such incidences result in stains that are extremely difficult or impossible to remove by cleaning methods and agents. To address such problems, typically tile producers apply a thin layer of surface coatings that are intended to close out the pores. However, these surface coatings are only temporary and are not intended to last long upon usage of the tiles after installation, particularly on high-traffic floors. Alternatively, the tiles can be fired at higher temperatures which will result in lower viscosities and therefore better closing of the pores, however, other properties including strength are found to decrease with higher firing temperatures and there is an increased in cost due to the extra fuel requirements for the higher firing temperatures.

Surprisingly, tiles that are fabricated from a tile composition that includes the metal oxide composition of the present invention exhibit a particularly low stain mark. i.e. the tile has very low porosity and therefore is more resistant to staining. Advantageously, this can reduce (or eliminate) the need for surface treatment after firing to fill up the open pores (which is both an expensive and non-robust solution) or alternatively allow lower firing temperatures.

Finally, the use of a zircon-metal oxide containing whitener-opacifier agent including the metal oxide composition of the invention allows the firing temperature to be reduced by at least 20° C. while maintaining the same or similar level of whiteness in comparison with an alumina whitener-opacifier. Alternatively, if the firing temperature is maintained, the use of a zircon whitener-opacifier including the metal oxide composition of the invention provides for a tile with greater strength and/or enhanced whiteness and lower stain mark.

### EXAMPLES

### Example 1

This example reports the preparation of a metal oxide composition from a precursor composition, and the use of the subsequent metal oxide composition to form a tile.

To prepare the metal oxide raw materials containing MgO, CaO, Al2O3, SiO2 and zircon were dry blended using a planetary mixer or mill for 5 minutes according to the composition outlined in Table 1 below:

TABLE 1
Precursor composition used to
form metal oxide composition

| Component | Weight % |
|---|---|
| Al₂O₃ | 17 |
| Zircon 5 micron | 35 |
| MgO/CaO | 48 |

The metal oxide composition was then blended with zircon to form a zircon-metal oxide containing whitener-opacifier that is a blend of 80% zircon and 20% metal oxide composition. The zircon-metal oxide blend was then added to a standard ceramic composition (outlined in Table 2 below) as a substitute whitener-opacifier in place of a typical whitener-opacifier agent consisting of zircon.

TABLE 2
Typical precursor tile composition
with metal oxide composition

| Component | Weight fraction |
|---|---|
| Clay | 23.8 wt % |
| Kaolin | 15.8 wt % |
| Quartz | 14.4 wt % |
| Feldspar | 36.0 wt % |
| zircon-metal oxide | 10.0 wt % |
| containing whitener- | |
| opacifier | |

500 g of the precursor tile composition was mixed with 250 g of water and 3.5 g of sodium silicate (a dispersing agent) before being milled in a planetary mill to achieve a dry residue between 1-2% and 63 microns. Subsequently, the milled ceramic composition was dried in an oven at 110° C.

The dried and milled ceramic composition was mixed with water to achieve a water content of 6 wt % and then pressed in a laboratory press at 400 kg/cm² to form green tile body samples of dimensions 110 mm×55 mm×9 mm. It was noted that the green tile bodies with 10 wt % zircon-metal oxide containing whitener-opacifier agent (e.g. a blend of zircon with the metal oxide composition of the present invention) had improved mechanical strength in comparison with tile bodies of a typical whitening-opacifying agent of only zircon (i.e. without the metal oxide composition of the present invention). Table 3 below provides a summary of the physical properties of the green tile bodies with and without opacifier.

TABLE 3
Physical properties of green tile bodies with 10%
of a 100% zircon whitener-opacifier and 10%
of a zircon-metal oxide containing whitener-opacifier

| | With 10 wt % typical | With 10 wt % |
|---|---|---|
| | whitening- | zircon-metal |
| | opacifying | oxide containing |
| | agent of | whitener- |
| Measured Parameter | only zircon | opacifier |
| Green body mechanical strength | 7.33 kg/cm² | 9.23 kg/cm² |
| Dry mechanical strength | 20.86 kg/cm² | 31.19 kg/cm² |

From Table 3, the presence of the metal oxide composition has increased both the green tile body and dry tile body strength. This offers a significant advantage and is a surprising result as the presence of a standard zircon whitener-opacifier actually results in a slight decrease in the green tile body and dry tile body strength to that achieved when no whitener-opacifier is added to the tile body mix before firing.

The dry tile bodies were then fired in a laboratory kiln to form a tile. Table 4 below provides summary of the measured physical properties of the fired tile with 10% zircon whitener-opacifier, and with 10 wt % zircon-metal oxide containing whitener-opacifier agent (e.g. a blend of zircon with the metal oxide composition of the present invention with 20% meta oxide plus 80% zircon whitener-opacifier).

TABLE 4
Physical properties of tiles with zircon only
whitener-opacifier and zircon-metal oxide
containing whitener-opacifier

| | With 10 wt | |
|---|---|---|
| | % typical | With 10 wt % |
| | whitening- | zircon-metal |
| | opacifying | oxide containing |
| | agent of | whitener- |
| Measured Parameter | only zircon | opacifier |
| Firing Temperature | 1220° C. | 1220° C. |
| (production scale) | (peak densification | (20° C. above peak |
| | temperature) | densification |
| | | temperature) |
| Lineal shrinkage | 7.34% | 7.99% |
| Color: L | 87.89 | 88.00 |
| Color: a | −0.16 | −0.23 |
| Color: b | 7.85 | 7.82 |
| Fired apparent density | 2.47 kg/cm³ | 2.48 kg/cm³ |
| Stain mark (ΔE) | 9.68 | 3.78 |

The results in Table 4 show that the presence of the metal oxide composition in the whitener-opacifier improves several physical properties of the tile. In particular, the stain mark is significantly improved (a lower value being more desirable) and the colour is similar if slightly improved compared to the zircon only whitener-opacifier. Furthermore, the peak densification point of the tile occurs at a lower temperature.

In view of the above, the incorporation of the metal oxide compositions of the invention results improved green tile body and dry tile body strength, and increased opacity of the resultant tiles, as well as reduced porosity (which reduces the problem of tile stainability on the non-glazed tile surfaces).

### Whiteness

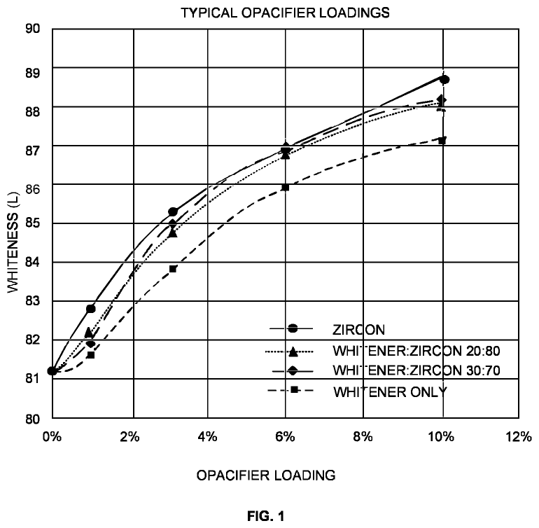

FIG. 1 is a graph showing the ‘L*-value’ as a function of whitener-opacifier loading in a glaze for a standard 100% zircon glaze; a 100% glaze formed by roasting the metal oxide composition of the present invention: a 50:50, 70:30, and 80:20 mixture of a zircon-metal oxide containing whitener-opacifier of the present invention; and a 100% zircon whitener-opacifier. The results show that the blends can achieve similar ‘L-value’ to the 100% zircon whitener-opacifier.

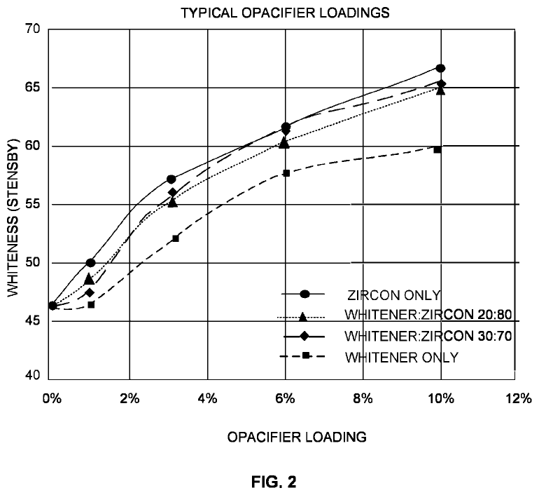

FIG. 2 is a graph showing the Stensby whiteness index as a function of opacifier loading for a 100% zircon; a 100% roasted metal oxide composition of the present invention: a 50:50, 70:30, and 80:20 zircon-metal oxide containing whitener-opacifier composition of the present invention; and a 100% zircon whitener-opacifier. By way of background, the Stensby whiteness index is defined using the L, a & b scales as L−3b+3a. This is different to using L on its own as a measurement of whiteness as it additionally considers aspects of the colour parameters ‘a’ and ‘b’. The results show that the blends can achieve similar whiteness to the 100% zircon whitener-opacifier.

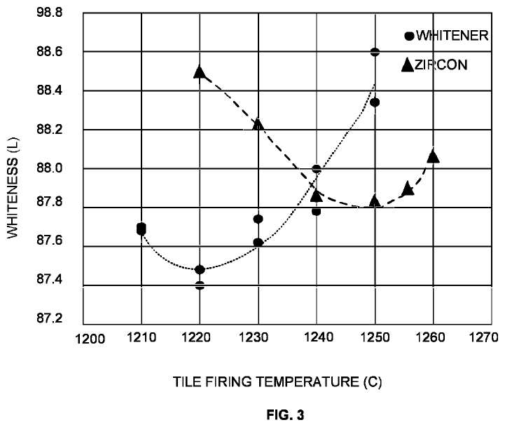

The inventors have also observed that higher firing temperatures result in a higher whiteness (L*-value); and that the slope of L*-value increase against temperature increase is higher and at lower temperatures when compared with a standard zircon whitener-opacifier for the same loading. This is illustrated in FIG. 3. FIG. 3 is a graph showing whiteness (L) as a function of firing temperature for tile compositions including standard zircon whitener-opacifiers, and zircon-metal oxide containing whitener-opacifiers of the present invention. The x-axis in FIG. 3 indicates the temperature for laboratory scale results. Production scale for firing temperature is 20° C. lower.

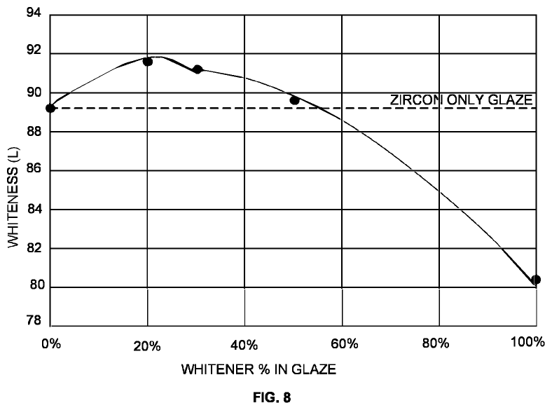

The inventors have also observed improved whiteness in glazes that include a proportion of zircon-metal oxide containing whitener-opacifier according to the present invention. FIG. 8 is a graph showing the whiteness (L*-value) for a glaze applied to a standard coloured tile body as a function of the loading of the zircon-metal oxide containing whitener-opacifiers of the present invention in the glaze. The results show the improvement in whiteness over zircon only glazes (0% value) for loadings of up to 50% metal oxide.

### Strength

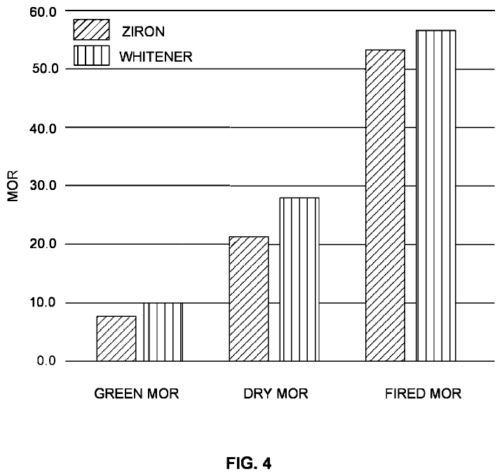

FIG. 4 is a graph showing the increased MOR of a tile in the green, dry, and fired forms for respective tile compositions including an 80:20 zircon-metal oxide containing whitener-opacifier blend as compared with a 100% zircon whitener-opacifier.

### Porosity

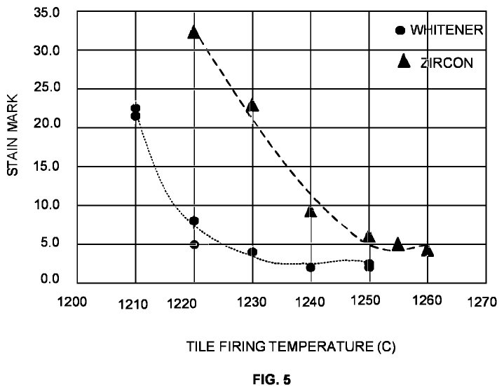

FIG. 5 shows the decrease in stain mark (representative of porosity) with increasing temperature for the tiles formed using an 80:20 zircon-metal oxide containing whitener-opacifier blend at lower temperatures as compared with 100% zircon whitener-opacifier. The x-axis in FIG. 5 indicates the temperature for laboratory scale results. Production scale for firing temperature is 20° C. lower.

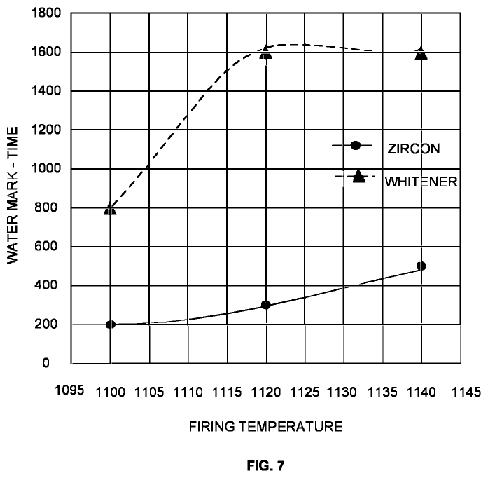

FIG. 7 is a graph of water mark as a function of firing temperature for engobe compositions including standard zircon whitener-opacifiers, and zircon-metal oxide containing whitener-opacifiers of the present invention. This test measures the time for a staining fluid (e.g. water or methylene blue) applied to the back of a wall tile to appear on the front of the tile. For an unglazed tile, the water mark time is typically about 45 seconds. FIG. 7 compares results for a standard tile include (i) an engobe containing zircon, and (ii) an engobe containing a zircon-metal oxide whitener-opacifier composition according to the present invention. As can be seen, the presence of an engobe greatly increases the water mark time. However, the results also clearly demonstrate an improvement in water mark time when moving from a standard engobe including zircon to one including the zircon-metal oxide whitener-opacifier composition of the present invention. Generally, a water mark time of greater than 800 s represents the limits of measuring. The reference to 1600 s is used as a representation of an engobe that is generally impervious to staining. The x-axis in FIG. 7 indicates the temperature for laboratory scale results. Production scale for firing temperature is 20° C. lower.

### Lower Firing Temperature

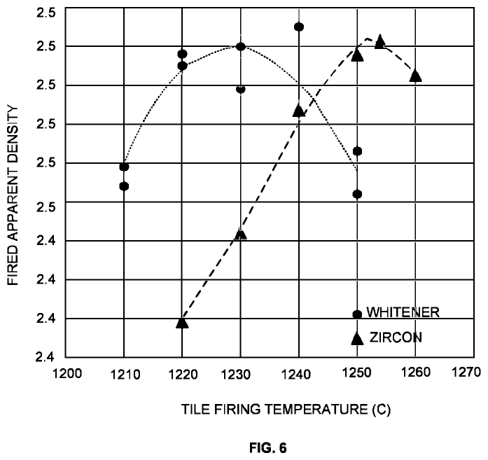

FIG. 6 is a graph showing the fired apparent density of the tile as a function of firing temperature for 100% zircon and a 80:20 mixture of zircon and the roasted metal oxide composition of the present invention. Ideally, the operating point is at the peak of the curve as this represents a tile body having the greatest density and lowest porosity. The results show that the zircon-metal oxide whitener-opacifier blends of the invention are able to achieve a maximum density at some 20° C. lower than the temperature required for a tile that is otherwise the same but includes a 100% zircon whitener-opacifier. Thus, the use of a zircon-metal oxide whitener-opacifier blend of the invention results in reduced energy costs (through a reduced kiln operation temperature) while achieving the same level of whiteness in comparison with a 100% zircon whitener-opacifier. The x-axis in FIG. 6 indicates the temperature for laboratory scale results. Production scale for firing temperature is 20° C. lower.

It will be understood that the invention disclosed and defined in this specification extends to all alternative combinations of two or more of the individual features mentioned or evident from the text or drawings. All of these different combinations constitute various alternative aspects of the invention.

As used herein, the indefinite article “a” or “an” carries the meaning of “one or more.”

The present inventions may also be described and understood via the following clauses: A ceramic body comprising a metal oxide composition which includes one or more crystalline metal oxides or crystalline mixed metal oxides of Al, Ca, Mg, Si, and Zr; wherein the metal oxide composition includes at least:

Al in an amount of from about 5 wt % to about 40 wt % measured as Al₂O₃;

Ca in an amount of from about 10 wt % to about 30 wt % measured as CaO;

Mg in an amount of from about 0 wt % to about 25 wt % measured as MgO;

Si in an amount of from about 10 wt % to about 25 wt % measured as SiO₂; and

Zr in an amount of from about 15 wt % to about 35 wt % measured as ZrO₂.

A ceramic body comprising a zircon-metal oxide-containing whitener-opacifier that includes zircon silicate blended with from 10-90% wt % of a metal oxide composition that includes at least:

Al in an amount of from about 5 wt % to about 40 wt % measured as Al₂O₃;

Ca in an amount of from about 10 wt % to about 30 wt % measured as CaO;

Mg in an amount of from about 0 wt % to about 25 wt % measured as MgO;

Si in an amount of from about 10 wt % to about 25 wt % measured as SiO₂; and

Zr in an amount of from about 15 wt % to about 35 wt % measured as ZrO₂.

1. A metal oxide composition for use in ceramic bodies, comprising one or more crystalline metal oxides or crystalline mixed metal oxides of Al, Ca, Mg, Si, and Zr;
wherein the metal oxide composition includes at least:
Al in an amount of from about 5 wt % to about 40 wt % measured as Al₂O₃;
Ca in an amount of from about 10 wt % to about 30 wt % measured as CaO;
Mg in an amount of from about 0 wt % to about 25 wt % measured as MgO;
Si in an amount of from about 10 wt % to about 25 wt % measured as SiO₂; and
Zr in an amount of from about 15 wt % to about 35 wt % measured as ZrO₂.

2. A zircon-metal oxide-containing whitener-opacifier for use in ceramic bodies, comprising zircon silicate blended with from 10-90 wt % of the metal oxide composition of claim 1.

3. A zircon-metal oxide-containing whitener-opacifier for use in ceramic bodies, comprising zircon silicate blended with from 20 to 30 wt % of the metal oxide composition of claim 1.

4. A zircon-metal oxide-containing whitener-opacifier for use in ceramic bodies, comprising zircon silicate blended with from 30% to 90 wt % of the metal oxide composition of claim 1.

5. A method for forming a green ceramic body comprising: adding from about 0.1 wt % to about 20 wt % of the metal oxide composition of claim 1 to a base ceramic composition and forming a green ceramic body.

6. A method for coating or glazing a green ceramic body comprising:
coating or glazing at least one surface of a green ceramic body with a metal oxide composition for use in ceramic bodies, comprising one or more crystalline metal oxides or crystalline mixed metal oxides of Al, Ca, Mg, Si, and Zr;
wherein the metal oxide composition includes at least:
Al in an amount of from about 5 wt % to about 40 wt % measured as Al₂O₃;
Ca in an amount of from about 10 wt % to about 30 wt % measured as CaO;
Mg in an amount of from about 0 wt % to about 25 wt % measured as MgO;
Si in an amount of from about 10 wt % to about 25 wt % measured as SiO₂; and
Zr in an amount of from about 15 wt % to about 35 wt % measured as ZrO₂.

7. A green ceramic body formed according to the method of claim 5.

8. A method of forming a ceramic, the method comprising:
forming a green ceramic body according to the method of claim 5; and
firing the green ceramic body to form the ceramic.

9. The method of claim 6 wherein an average firing temperature of 1,220° C. is used in forming the ceramic.

10. The method of claim 8 wherein the green ceramic body is tired within a range of from 1,150° C. to 1,250° C. to form the ceramic.

11. A method of preparing a ceramic, the method comprising:
providing a green ceramic body including a metal oxide composition for use in ceramic bodies, comprising one or more crystalline metal oxides or crystalline mixed metal oxides of Al, Ca, Mg, Si, and Zr;
wherein the metal oxide composition includes at least:
Al in an amount of from about 5 wt % to about 40 wt % measured as Al₂O₃;
Ca in an amount of from about 10 wt % to about 30 wt % measured as CaO;
Mg in an amount of from about 0 wt % to about 25 wt % measured as MgO;
Si in an amount of from about 10 wt % to about 25 wt % measured as SiO₂; and
Zr in an amount of from about 15 wt % to about 35 wt % measured as ZrO₂; and
firing the green ceramic body to form the ceramic.

12. The method of claim 11 wherein an average firing temperature of 1,220° C. is used in forming the ceramic.

13. The method of claim 11 wherein the green ceramic body is fired within a range of from 1,150° C. to 1.250° C. to form the ceramic.

14. A ceramic composition formed according to the method of claim 11.

15. A ceramic composition comprising the zircon-metal oxide-containing whitener-opacitier of claim 2 in an amount of from about 0.1 wt % to about 20 wt %.

16. The ceramic composition of claim 14 characterized by the following:
a whiteness (L*-value) of 87-97; and
a stain mark (ΔE) of 1.40-4.75.

17. The ceramic composition of claim 16 further characterized by a zircon load of from 0.1 wt % to 20 wt %.

18. An opacified ceramic composition characterized by the following properties:
a whiteness (L*-value) of 87-97;
a stain mark (ΔE) of 1.40-4.75; and
a zircon load of from 0.1 wt % to 20 wt.

19. A method for forming a green ceramic body comprising: adding from about 0.1 wt % to about 20 wt % of the zircon-metal oxide-containing whitener-opacifier composition of claim 2 to a base ceramic composition and forming a green ceramic body.

20. A method of preparing a ceramic, the method comprising:
providing a green ceramic body including the zircon opacifier composition of claim 2; and
firing the green ceramic body to form the ceramic.
